(19) United States
(12) Patent Application Publication
(10) Pub. No.: US 2024/0430842 A1
(43) Pub. Date: Dec. 26, 2024

(54) OPPORTUNISTIC MULTIPLE CARRIERS BASED FINE RANGING

(71) Applicant: Samsung Electronics Co., Ltd., Suwon-si (KR)

(72) Inventors: Wei Sun, Allen, TX (US); Shunyao Wu, Allen, TX (US); Hao Chen, Allen, TX (US); Vishnu Vardhan Ratnam, Plano, TX (US); Jianzhong Zhang, Plano, TX (US)

(21) Appl. No.: 18/523,844

(22) Filed: Nov. 29, 2023

Related U.S. Application Data
(60) Provisional application No. 63/523,004, filed on Jun. 23, 2023.

(51) Int. Cl. H04W 64/00; H04B 7/06; H04W 72/02; H04W 72/0453

(52) U.S. Cl. CPC H04W 64/00; H04B 7/0626; H04W 72/02; H04W 72/0453

(57) ABSTRACT

Methods and apparatuses for operating multiple carriers in a wireless communication system. A method for a first network entity comprises: identifying a plurality of carrier frequencies for measuring carrier phases from a set of predefined carrier frequencies; estimating, based on the measured carrier phase, a distance between the first network entity and a second network entity using a carrier ranging operation that is performed between the first network entity and the second network entity; selecting, based on the estimated distance, historical information, a variation of measured distance, and channel status information, at least one carrier frequency from the plurality of carrier frequencies to refine distance measurement; and transmitting, to and receive from the second network entity, signals over the selected at least one carrier frequency.

### CROSS-REFERENCE TO RELATED APPLICATIONS AND CLAIM OF PRIORITY

The present application claims priority to U.S. Provisional Patent Application No. 63/523,004, filed on Jun. 23, 2023. The contents of the above-identified patent documents are incorporated herein by reference.

### TECHNICAL FIELD

The present disclosure relates generally to wireless communication systems and, more specifically, the present disclosure relates to an opportunistic multiple carriers based fine ranging operation in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to an opportunistic multiple carriers based fine ranging operation in a wireless communication system.

In one embodiment, a first network entity for operating multiple carriers is provided. The first network entity comprises a processor configured to: identify a plurality of carrier frequencies for measuring carrier phases from a set of predefined carrier frequencies, estimate, based on the measured carrier phases, a distance between the first network entity and a second network entity using a carrier ranging operation that is performed between the first network entity and the second network entity, select, based on the estimated distance, historical information, a variation of measured distance, and channel status information, at least one carrier frequency from the plurality of carrier frequencies to refine distance measurement. The first network entity further comprises a transceiver operably coupled to the processor, the transceiver configured to transmit to and receive from, the second network entity, signals over the selected at least one carrier frequency.

In another embodiment, a method of a first network entity for operating multiple carriers is provided. The method comprises: identifying a plurality of carrier frequencies for measuring carrier phases from a set of predefined carrier frequencies; estimating, based on the measured carrier phase, a distance between the first network entity and a second network entity using a carrier ranging operation that is performed between the first network entity and the second network entity; selecting, based on the estimated distance, historical information, a variation of measured distance, and channel status information, at least one carrier frequency from the plurality of carrier frequencies to refine distance measurement; and transmitting, to and receive from the second network entity, signals over the selected at least one carrier frequency.

In yet another embodiment, a non-transitory computer-readable medium comprising program code, that when executed by at least one processor, causes an electronic device to: identify a plurality of carrier frequencies for measuring carrier phases from a set of predefined carrier frequencies; estimate, based on the measured carrier phases, a distance between a first network entity and a second network entity using a carrier ranging operation that is performed between the first network entity and the second network entity; select, based on the estimated distance, historical information, a variation of measured distance, and channel status information, at least one carrier frequency from the plurality of carrier frequencies to redefine distance measurement; and transmit, to and receive from the second network entity, signals over the selected at least one carrier frequency.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate example of wireless transmit and receive paths according to this disclosure;

FIG. 6 illustrates an example of system component according to embodiments of the present disclosure;

FIG. 7 illustrates a flowchart of method for a ranging manager operation according to embodiments of the present disclosure;

FIG. 8 illustrates a flowchart of method for a carrier manager operation according to embodiments of the present disclosure;

FIG. 9 illustrates a flowchart of method for a single carrier ranging operation according to embodiments of the present disclosure;

FIG. 10 illustrates a flowchart of method for a double carriers ranging operation according to embodiments of the present disclosure;

FIG. 11 illustrates a flowchart of method for a multiple carrier multiple state fine ranging operation according to embodiments of the present disclosure; and

FIG. 12 illustrates a flowchart of method for an opportunistic multiple carriers based fine ranging operation according to embodiments of the present disclosure.

### DETAILED DESCRIPTION

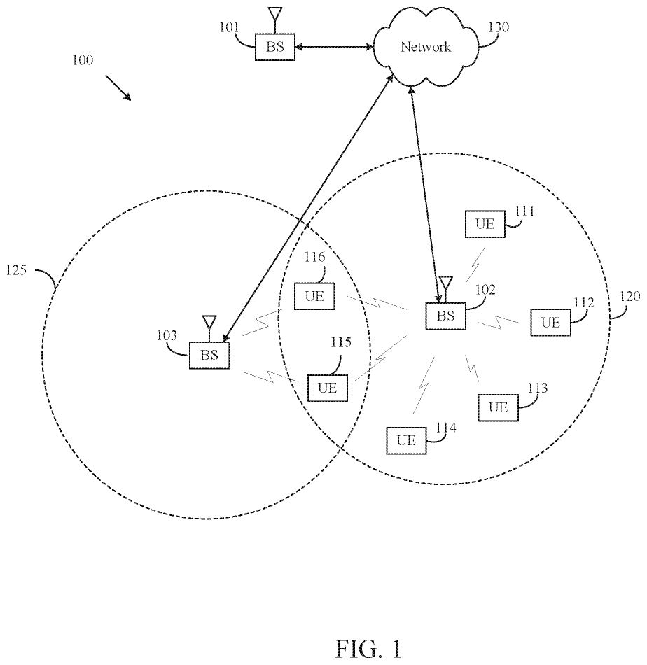

FIG. 1 through FIG. 12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents are hereby incorporated by reference into the present disclosure as if fully set forth herein: 3GPP TS 38.211 v17.2.0, “NR; Physical channels and modulation”; 3GPP TS 38.212 v17.2.0, “NR; Multiplexing and Channel coding”; 3GPP TS 38.213 v17.2.0, “NR; Physical Layer Procedures for Control”; 3GPP TS 38.214 v17.2.0, “NR; Physical Layer Procedures for Data”; 3GPP TS 38.215 v17.1.0, “NR; Physical layer measurements”; 3GPP TS 38.321 v17.1.0, “NR; Medium Access Control (MAC) protocol specification”; 3GPP TS 38.331 v17.1.0, “NR; Radio Resource Control (RRC) Protocol Specification”; and 3GPP TS 38.133 v17.6.0, “NR; Requirements for support of radio resource management.”

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network. In one embodiment, the gNB (101-103) may perform an opportunistic multiple carriers based fine ranging operation as a transmitter or a receivers.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques. In one embodiment, the UEs 111-116 may perform an opportunistic multiple carriers based fine ranging operation as a transmitter or a receivers.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for performing an opportunistic multiple carriers based fine ranging operation in a wireless communication system. In certain embodiments, and one or more of the gNBs 101-103 includes circuitry, programing, or a combination thereof, for supporting an opportunistic multiple carriers based fine ranging operation in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks. In one embodiment, the UEs 111-116 may perform an opportunistic multiple carriers based fine ranging operation as a transmitter or a receivers.

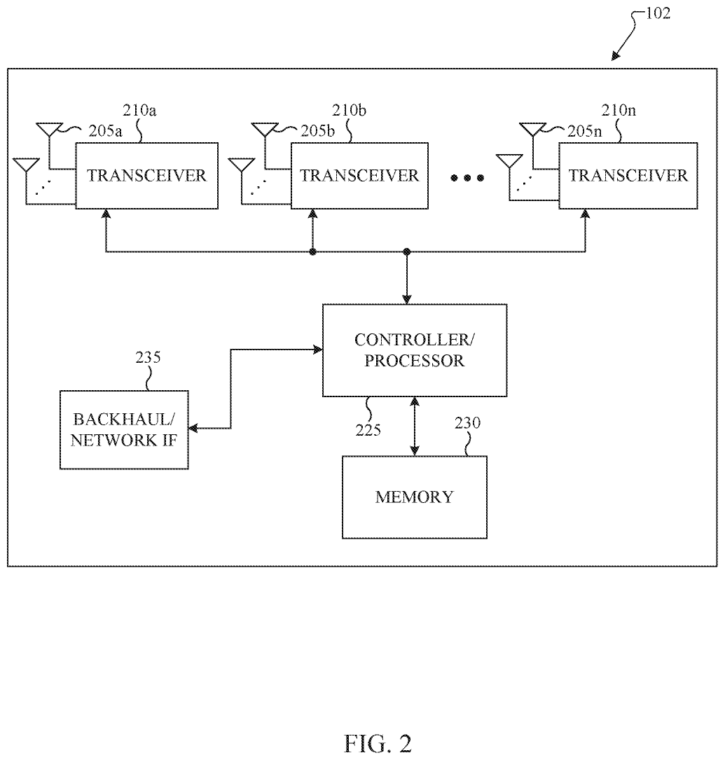

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes for supporting an opportunistic multiple carriers based fine ranging operation in a wireless communication system. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

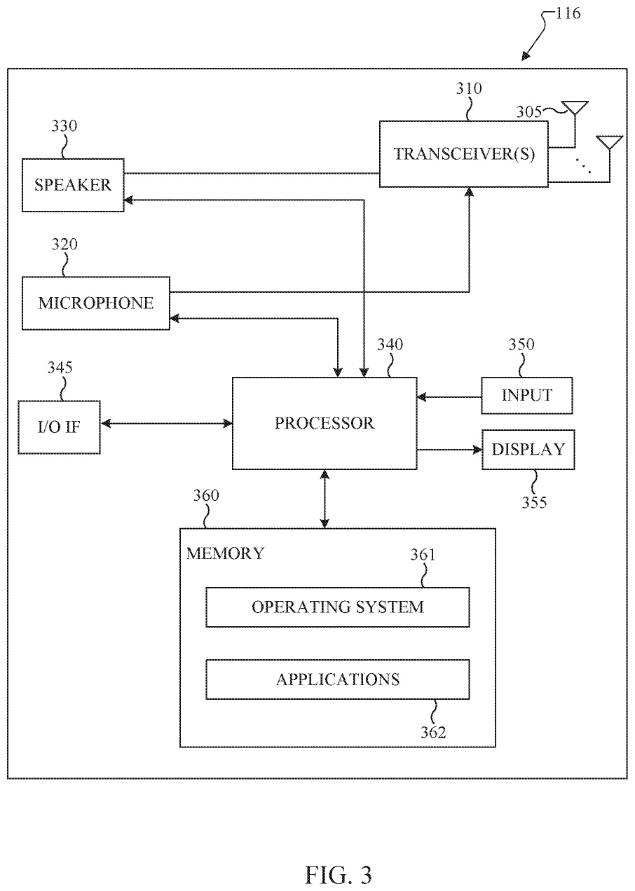

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for an opportunistic multiple carriers based fine ranging operation in a wireless communication system.

The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355m which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

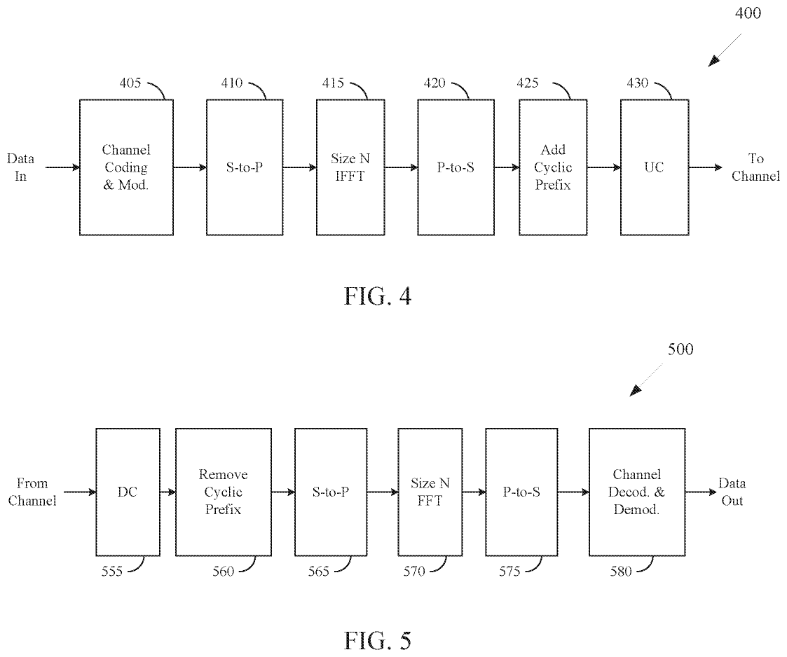

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In some embodiments, the receive path 500 is configured to support CSI measurement and report with operation state adaptation in a wireless communication system.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the downconverter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103. In one embodiment, the gNBs 101-103 may perform an opportunistic multiple carriers based fine ranging operation as a transmitter or a receivers.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

Indoor positioning has grown in popularity over the last decade in parallel with the growth in the number of personal wireless devices as well as wireless infrastructure. While the use cases are plentiful and include smart homes and buildings, surveillance, disaster management, industry and healthcare, they all require wide availability and good accuracy. A key step of most positioning/localization solutions is ranging which involves identification of the distance (or a difference in distances) of the target device from a set of anchor devices whose locations are known.

Correspondingly several ranging techniques have been provided in ultra-wide band (UWB), Lidar and WiFi. In fact, WiFi standards groups like IEEE 802.11mc and 802.11az have been specifically tailored for enabling accurate WiFi-based ranging via the fine timing measurement (FTM) mechanism, etc.

Existing positioning techniques require sufficient resource to support the accurate estimation with one or more following constraints: multiple positional anchors, plenty of temporal samples and large bandwidth. It will increase the cost of deployment and conflict with other wireless service in temporal, spatial or frequency domain. Besides, the limited bandwidth is the pain point of the ranging accuracy, which in turn limits the localizations accuracy at a same order.

In the present disclosure, a unified framework is provided to leverage one or several carriers to estimate the distance accurately with an opportunistic scheme. According to the channel status and the historical estimation, the provided method in the present disclosure can adaptatively select the carrier frequency to achieve a given frequency while minimizing the system overhead.

In one embodiment, a unified framework is provided to leverage one or more carriers to estimate a distance with an opportunistic scheme.

In one embodiment, a unified carrier phase fine ranging framework is provided to apply to WiFi, BLE and other wireless systems.

In one embodiment, adaptatively selecting, based on a channel status and a historical estimation, is provided for a carrier frequency to achieve a given frequency while minimizing a system overhead.

In one embodiment, an adaptative scheme is provided to minimize the system overhead for the fine ranging. An adaptative scheme selects the carrier frequencies accordingly based on the channel status, required accuracy and the historical estimation.

FIG. 6 illustrates an example of system 600 component according to embodiments of the present disclosure. An embodiment of the system 600 shown in FIG. 6 is for illustration only. As illustrated in FIG. 6, the system comprises a carrier manager, a ranging manager, and a transceiver (e.g., transmitter and receiver). Three functional components run in parallel according to the following breakdown.

In one example, a ranging manager may estimate the range based on the existing channel state information (CSI) or carrier phase information and the valid historical range and enable a new range measurement by requesting the carrier manager with the statistics of current range estimation.

In one example, carrier manager may schedule the carrier frequency queues and select the best carrier frequency for the measurement based on the current available channels and the statistics of the latest range estimation.

In one example, a transmitter/receiver (e.g., transceiver) measures the CSI or carrier phase by exchanging packets with each other through a specific carrier frequency requested by the carrier manager.

The purpose of the ranging manager (RM) is to produce and stream range measurements based on the streaming CSI or carrier phase measurements and to analyze the measurement statistics to guide the future measurements. The RM maintains a range queue (RQ) and a queue of CSI or carrier phase measurements (CQ) of each frequency and holds a time window to invalidate values in the queues.

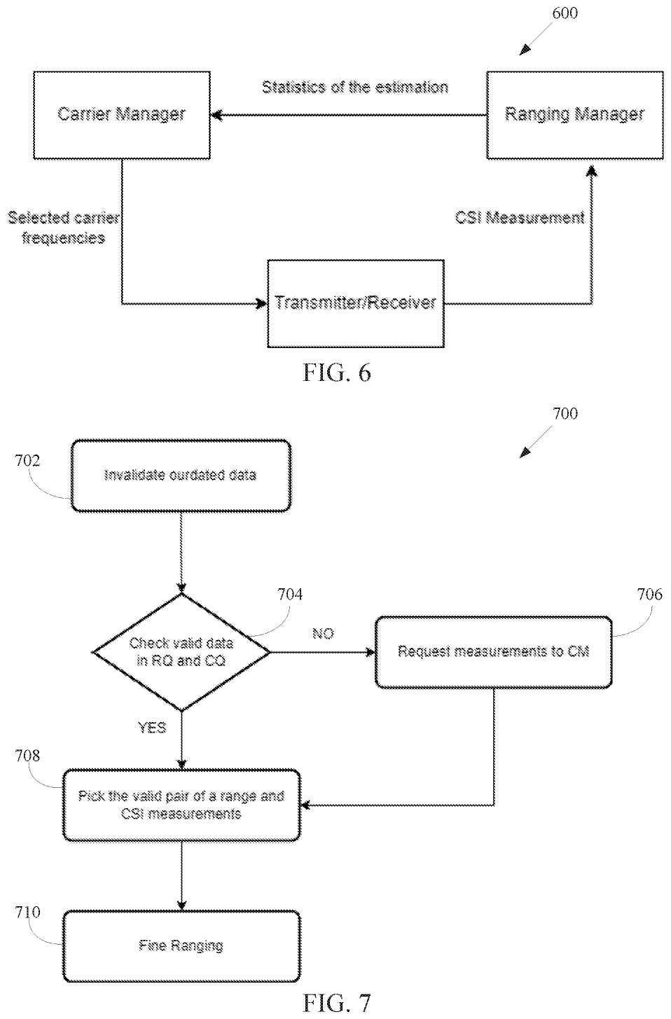

FIG. 7 illustrates a flowchart of method 700 for a ranging manager operation according to embodiments of the present disclosure. The method 700 as may be performed by a first network entity (e.g., UEs 111-116 as illustrated in FIG. 1 and BSs 101-103 as illustrated in FIG. 1). In one embodiment, the method 1200 as may be performed by a second network entity (e.g., UEs 111-116 as illustrated in FIG. 1 and BSs 101-103 as illustrated in FIG. 1). An embodiment of the method 700 shown in FIG. 7 is for illustration only. One or more of the components illustrated in FIG. 7 can be implemented in specialized circuitry configured to perform the noted functions or one or more of the components can be implemented by one or more processors executing instructions to perform the noted functions.

As illustrated in FIG. 7, the RM performs its functionalities by following steps.

In step 702, the RM invalidates the outdated data in RQ and CQ with current timestamp and the time window. In step 702, the RM checks the tail of RQ to find the latest valid estimation. If the information exists then scans if there are valid CSI or carrier phase measurements in CQ to for this estimation pruning. If these CSI measurements are available, goes to step 710. In step 706, the RM sends current range estimation to carrier manager with the statistics to request fine range measurement. If there is no valid range estimation, notifies carrier manager to start from the zero estimation. Waits for new CSI or carrier phase measurements from the transmitter and the receiver. In step 708, the RM picks the valid pair or a range and CSI measurements. In step 710, the RM performs the multi carrier fine range estimation with the valid range estimation and its corresponding valid CSI measurements. Pushes new data into the RQ and the CQ.

The purpose of the carrier manager (CM) is to schedule the most suitable carrier frequencies for the measurement request of the RM from the existing available channels. The CM maintains three different arrays to manage carrier frequencies including a list of available carrier frequencies in channels F_{c}, a list of effective measured carrier frequencies in an effective temporal window Fₑ and a list of requesting measurement carrier frequencies Fᵣ.

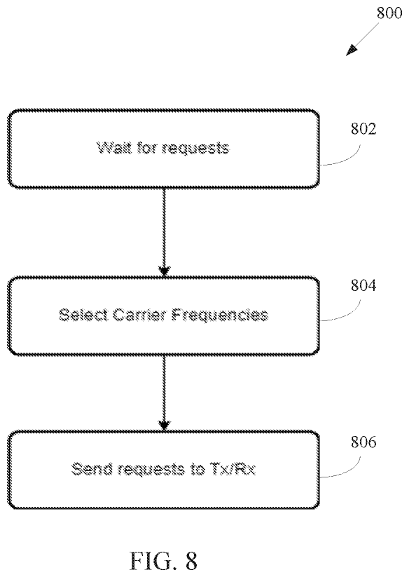

FIG. 8 illustrates a flowchart of method 800 for a carrier manager operation according to embodiments of the present disclosure. The method 800 as may be performed by a first network entity (e.g., UEs 111-116 as illustrated in FIG. 1 and BSs 101-103 as illustrated in FIG. 1). In one embodiment, the method 1200 as may be performed by a second network entity (e.g., UEs 111-116 as illustrated in FIG. 1 and BSs 101-103 as illustrated in FIG. 1). An embodiment of the method 800 shown in FIG. 8 is for illustration only. One or more of the components illustrated in FIG. 8 can be implemented in specialized circuitry configured to perform the noted functions or one or more of the components can be implemented by one or more processors executing instructions to perform the noted functions.

As illustrated in FIG. 8, the CM in step 802 waits for the latest requests and statistics of range estimation from the RM. In step 804, the CM selects the appropriate carrier frequencies from F_{c} that is not used in Fₑ and the most appropriate for the given range statistics. The method follows the multi carrier multi-stage fine ranging algorithm to pick up the carrier frequencies. In step 806, the CM pushes the carrier frequencies into Fᵣ and request the measurements for transmitter/receiver for all the frequencies in Fᵣ. The method cleans up Fᵣ and pushes the requested carrier frequencies into Fₑ to avoid unnecessary measurements on the same carrier frequency in a short period.

Transmitter/receiver follows the commands from CM to exchanging the packets over the requested carrier frequencies. The measured CSI is sent to RM together with its meta data.

In one embodiment, the provided system may apply single carrier to estimate the distance between the transmitter and the receiver directly based on d=λ(N+Δ) where d is the distance to be estimated from the Tx to Rx. λ is the wavelength of the carrier frequency. N is the integer number of the cycles of the carrier frequency. It is defined as

$$N = ⌊ \frac{d}{λ} ⌋ .$$

Δ is the fractional number of cycles which is defined as

$$Δ = \frac{d}{λ} - ⌊ \frac{d}{λ} ⌋ .$$

Δ is equal to where φ/2π is the φ carrier phase.

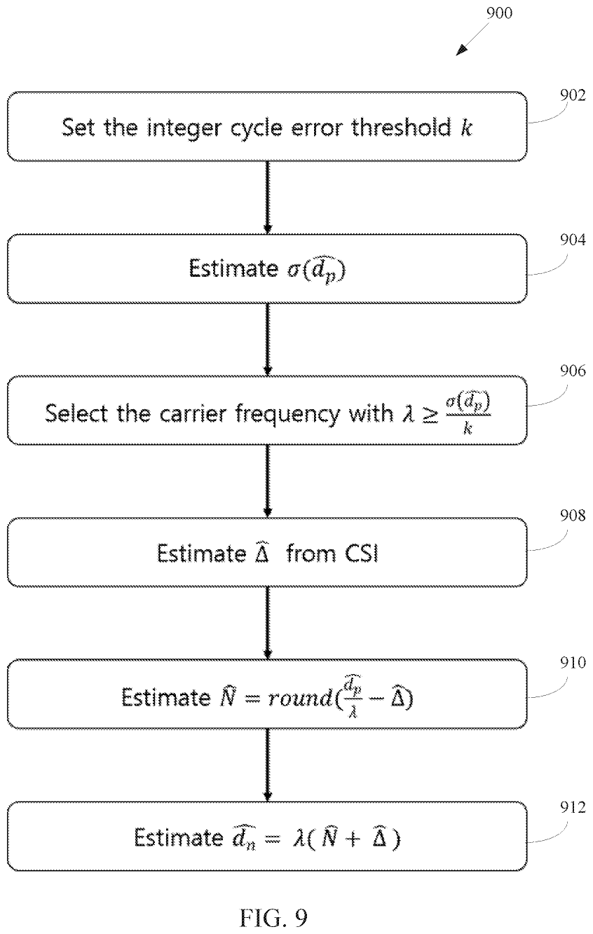

FIG. 9 illustrates a flowchart of method 900 for a single carrier ranging operation according to embodiments of the present disclosure. The method 900 as may be performed by a first network entity (e.g., UEs 111-116 as illustrated in FIG. 1 and BSs 101-103 as illustrated in FIG. 1). In one embodiment, the method 1200 as may be performed by a second network entity (e.g., UEs 111-116 as illustrated in FIG. 1 and BSs 101-103 as illustrated in FIG. 1). An embodiment of the method 900 shown in FIG. 9 is for illustration only. One or more of the components illustrated in FIG. 9 can be implemented in specialized circuitry configured to perform the noted functions or one or more of the components can be implemented by one or more processors executing instructions to perform the noted functions.

In one method, the carrier phase is estimated by the CSI which is captured by exchanging frames between Tx and Rx. The provided system takes following steps to measure d with a given integer cycle error threshold k. k is keen to control the variance of the estimate number of integer cycles \hat{N}. By setting k<0.5, it is highly possible to estimate \hat{N} without any bias.

As illustrated in FIG. 9, the method 900 begins at step 902. In step 902, the method sets the integer cycle error threshold k. In step 904, the method estimates the variance σ( [symbol] ) (based on previous estimation. In step 906, the method scans the available carrier frequency and selects the one whose carrier wavelength

$$λ \geq \frac{σ ( )}{k} .$$

n step 908, the method estimates \hat{Δ} from CSI or carrier phase measured on the selected carrier frequency. In step 910, the method estimates the integer number of cycles

$$\hat{N} = round ( \frac{λ}{} - \hat{Δ} ) .$$

The variance

$$σ ( \hat{N} ) \leq \frac{σ ( )}{λ} \leq k .$$

In step 912, the method estimates [symbol] =λ(\hat{N}+\hat{Δ}). σ( [symbol] )=λ\sqrt{σ(\hat{N})²+σ(\hat{Δ})²}. When \hat{N} is accurately estimated with the effective k, σ( [symbol] )=λσ(\hat{Δ}). In such steps, the method adds [symbol] to ranging manager. Report the current distance estimation as [symbol] and further smooth the estimation with historical estimations.

In another example, the initial variance of [symbol] could comes from other ranging techniques such as round-trip time or RSSI based.

In one embodiment, the provided system may apply double carriers to estimate the distance between transmitter and the receiver when either ranging manager does not have historical measurements to estimate the σ( [symbol] ) or there is not available carrier frequency to satisfy the given accuracy threshold.

The estimation requires two measurements of different carrier frequencies:

$$d = \frac{c}{{f}_{0}} ( {N}_{0} + {Δ}_{0} ) , d = \frac{c}{{f}_{1}} ( {N}_{1} + {Δ}_{1} )$$

where f₀ and f₁ are the two selected carrier frequency. c is the light speed. The two measurements are formulated as a single carrier ranging as

$$d = \frac{c}{{f}_{0} - {f}_{1}} ( {N}_{0} - {N}_{1} + {Δ}_{0} - {Δ}_{1} ) .$$

The frequency difference between f₀ and f₁ can produce a large equivalent wavelength

$${λ}_{0 , 1} = \frac{c}{{f}_{0} - {f}_{1}}$$

that is larger than

$${λ}_{0} = \frac{c}{{f}_{0}} and {λ}_{1} = \frac{c}{{f}_{1}} . {λ}_{0 , 1}$$

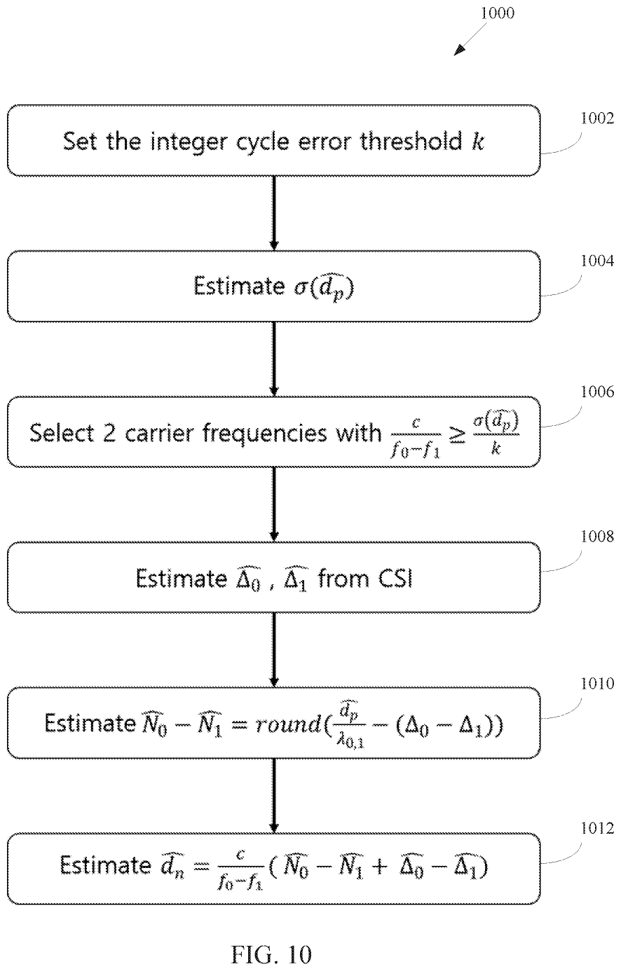

can satisfy the requirement to achieve the given integer cycle error threshold k as illustrated in FIG. 10.

FIG. 10 illustrates a flowchart of method 1000 for a double carriers ranging operation according to embodiments of the present disclosure. The method 1000 as may be performed by a first network entity (e.g., UEs 111-116 as illustrated in FIG. 1 and BSs 101-103 as illustrated in FIG. 1). In one embodiment, the method 1200 as may be performed by a second network entity (e.g., UEs 111-116 as illustrated in FIG. 1 and BSs 101-103 as illustrated in FIG. 1). An embodiment of the method 1000 shown in FIG. 10 is for illustration only. One or more of the components illustrated in FIG. 10 can be implemented in specialized circuitry configured to perform the noted functions or one or more of the components can be implemented by one or more processors executing instructions to perform the noted functions.

As illustrated in FIG. 10, the method in step 1002 sets the integer cycle error threshold k. In step 1004, the method estimates the variance σ( [symbol] ) based on previous estimations. In step 1006, the method scans the available carrier frequency and selects a pair of carrier frequencies f₀ and f₁ whose frequency difference satisfies

$$\frac{c}{{f}_{0} - {f}_{1}} \geq \frac{σ ( )}{k} .$$

In step 1008, the method estimates [symbol] from CSI measurement over carrier frequency f₀, f₁. In step 1010, the method estimates the integer number of cycles

$$- = round ( \frac{{λ}_{0 , 1}}{} - ( {Δ}_{0} - {Δ}_{1} ) ) .$$

The variance

$$σ ( - ) \approx \frac{σ ( )}{{λ}_{0 , 1}} \leq k .$$

In step 1012, the method estimates [symbol] =λ_{0,1}( [symbol] − [symbol] + [symbol] − [symbol] ). σ( [symbol] )=λ_{0,1} [symbol] . When [symbol] − [symbol] is accurately estimated with the effective k, σ( [symbol] )=λ_{0,1} [symbol] . In such steps, the method adds [symbol] to ranging manager. Report the current distance estimation as [symbol] and further smoothen the estimation with historical estimations.

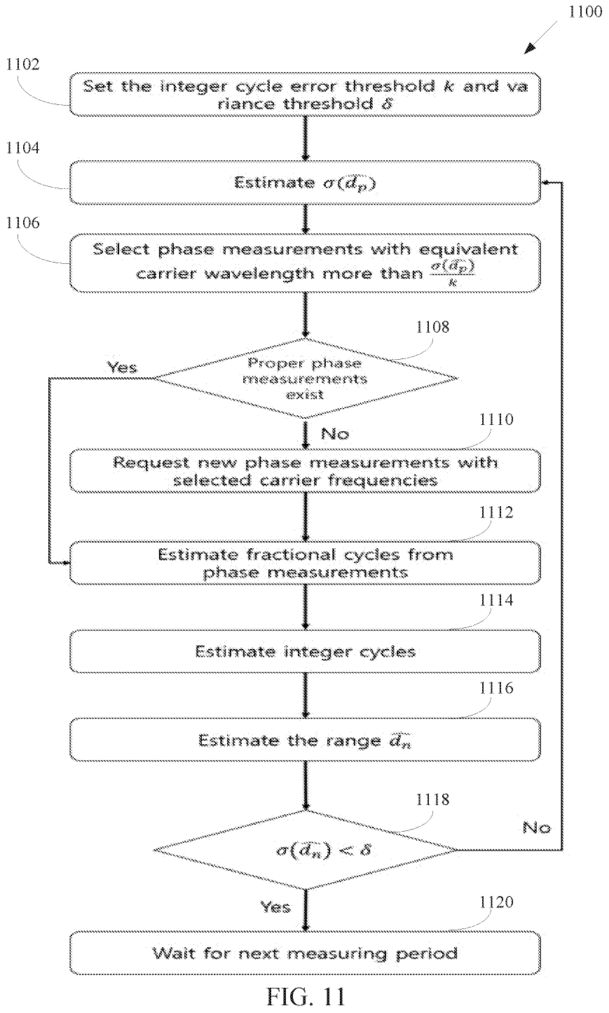

In one embodiment, the provided method leverages the advantages of single carrier ranging and double carrier ranging to achieve fine resolution accordingly. Single carrier ranging applies a small carrier wavelength to achieve the small fractional wavelength error but yield the large integer wavelength error. Double carrier ranging uses a large equivalent wavelength to achieve tiny integer wavelength error but holds a large fractional wavelength error. The provided method in the present disclosure selects appropriate carrier frequencies and leverage all potential equivalent frequencies to increase the estimation resolution progressively. CM and RM adjust the selective frequency to converge the estimation with a few rounds progressively with following steps as illustrated in FIG. 11.

FIG. 11 illustrates a flowchart of method 1100 for a multiple carrier multiple state fine ranging operation according to embodiments of the present disclosure. The method 1100 as may be performed by a first network entity (e.g., UEs 111-116 as illustrated in FIG. 1 and BSs 101-103 as illustrated in FIG. 1). In one embodiment, the method 1200 as may be performed by a second network entity (e.g., UEs 111-116 as illustrated in FIG. 1 and BSs 101-103 as illustrated in FIG. 1). An embodiment of the method 1100 shown in FIG. 11 is for illustration only. One or more of the components illustrated in FIG. 11 can be implemented in specialized circuitry configured to perform the noted functions or one or more of the components can be implemented by one or more processors executing instructions to perform the noted functions.

As illustrated in FIG. 11, the method in step 1102 sets up the integer cycle error threshold k and the range estimation variance threshold δ. k is set to be a small value. In step 1104, the method estimates the variance σ( [symbol] ) based on either previous estimations or other ranging algorithms. Assumes [symbol] is within the maximal effective equivalent carrier wavelength if there is no valid historical estimation. In step 1106, the method scans the valid measured carrier frequencies to check whether there are unused CSI or carrier phase measurements that can satisfy the threshold

$$\frac{σ ( )}{k} .$$

Both single carrier range case and double carrier range may be qualified. If the qualified CSI measurements exist, go to step 1112. Otherwise, selects qualified carrier frequencies from F_{c} in current channel. In step 1108, the method determines whether CSI exists and CSI is valid.

In step 1110, the method performs CSI or carrier phase measurements over the selected carrier frequencies. In step 1112, the method estimates the fractional cycles based on the CSI measurements. In step 1114, the method estimates the integer cycles based on the estimated fractional cycles and [symbol] . The estimation follows either single carrier ranging or double carrier ranging based on the selected carrier frequencies in the last step. In step 1116, the method estimates the range [symbol] based on the integer and the fractional cycles. In step 1118, the method estimates the variance σ( [symbol] ). If σ( [symbol] ) has met the range estimation variance threshold δ, wait in step 1120 for a period to perform next range measurement. Otherwise, the method goes to step 1104 to start a new measurement to estimate a finer resolution.

In one embodiment, the provided system guarantees the convergence of the ranging variance by decreasing the carrier wavelength gradually and keeping the error of the integer cycles tiny. In one example, the predefined threshold k is set for

$$\frac{σ ( )}{λ}$$

to be smaller than 0.2 and the variance of \hat{Δ} is smaller than 0.05 commonly. The variance of

$$\frac{λ}{} - \hat{Δ}$$

is close to k so that it is highly possible to estimate the exact integer cycles after rounding

$$\frac{λ}{} - \hat{Δ}$$

with a small variance.

Finally, the variance of new estimation σ( [symbol] )=λ\sqrt{σ(\hat{N})²+σ(\hat{Δ})²}=λσ(\hat{Δ}) when the \hat{N} is controlled to be exactly correct. The variance is decreased by the ratio

$$\frac{σ ( )}{σ ( )} \leq \frac{k λ}{λσ ( \hat{Δ} )} = \frac{k}{σ ( \hat{Δ} )} >> 1.$$

By selecting

$$λ \approx \frac{σ ( \hat{{d}_{p}} )}{k} , the \frac{σ ( \hat{{d}_{p}} )}{σ ( )}$$

can be always much more than 1 so that the estimate can converge with several iterations. By selecting

$$λ \geq \frac{σ ( )}{k} , the \frac{σ ( \hat{{d}_{p}} )}{σ ( )}$$

the can be always much more than 1 so that the estimate can converge with several iterations.

In one example, a BLE system may be considered. The minimal band spacing is 1 Mhz. Consider \hat{d}₀ is unknown but still falls into the max range, i.e., 300 m,

$$k = \frac{σ ( \hat{d} )}{λ} = 0.2 , σ ( \hat{Δ} ) = 0.05 .$$

For the BLE system, followings steps may be performed.

In one example of Step 1, select f_{0,1}=1 MHz, \hat{N}₀=0, then σ(\hat{d}₀)=\sqrt{2}λ_{0,1}σ(\hat{Δ})=21 m.

In one example of Step 2, select

$$λ \geq \frac{σ ( {\hat{d}}_{0} )}{k} = 105 m , {f}_{0 , 2} = 2 MHz ,$$

σ(\hat{d}₁)=\sqrt{2}λ_{0,1}σ(\hat{Δ})=10.6 m.

In one example of Step 3, select λ≥53.0 m, f_{0,3}=5 MHz, σ(\hat{d}₂)=\sqrt{2}λ_{0,3}σ(\hat{Δ})=4.24 m.

In one example of Step 4, select λ≥21.2 m, f_{0,4}=14 MHz, σ(\hat{d}₃)=\sqrt{2}λ_{0,4}σ(\hat{Δ})=1.52 m.

In one example of Step 5, select λ≥7.57 m, f_{0,5}=39 MHz, σ(\hat{d}₄)=\sqrt{2}λ_{0,5}σ(\hat{Δ})=0.54 m.

In one example of Step 6, select λ≥2.72 m, f_{0,6}=80 MHz, σ(\hat{d}₅)=\sqrt{2}λ_{0,6}σ(\hat{Δ})=0.27 m.

In this case, only 6 carrier frequencies are required without any initial estimation. Less carriers are required when a coarse initial estimation exists.

In yet another example, a Wi-Fi system with σ(\hat{d}₀)≈2 m may be considered. This system could be determined from other technology, for example, set k≈0.1 for a more stable estimation for integer. σ(\hat{Δ})=0.01 for each carrier according to experiments.

In one example of Iteration 1,

$$λ \geq \frac{σ ( {\hat{d}}_{0} )}{k} = 20 m ,$$

select f_{0,1}=10 MHz, λ_{0,1}=30 m, σ(\hat{d}₀)=30*\sqrt{2}*0.01=0.42 m.

In one example of Iteration 2, λ≥4.2 m, select f_{0,2}=60 MHz, λ_{0,2}=5 m, σ(\hat{d}₁)=5*\sqrt{2}*0.01=0.071 m.

In one example of Iteration 3, λ≥0.71 m, select f_{0,3}=420 Mhz, λ_{0,3}=0.71 m, σ(\hat{d}₂)=0.71*\sqrt{2}*0.01=0.01 m.

In one example of Iteration 4, λ≥0.10 m, select f₃=2.4 GHz, λ₃=0.125 m, σ(\hat{d}₃)=0.125*0.01=0.00125 m.

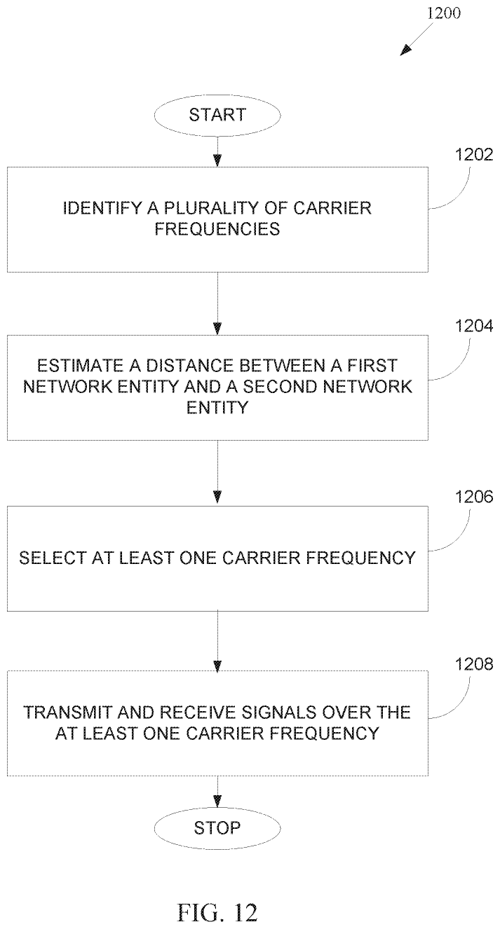

FIG. 12 illustrates a flowchart of method 1200 for an opportunistic multiple carriers based fine ranging operation according to embodiments of the present disclosure. The method 1200 as may be performed by a first network entity (e.g., UEs 111-116 as illustrated in FIG. 1 and BSs 101-103 as illustrated in FIG. 1). In one embodiment, the method 1200 as may be performed by a second network entity (e.g., UEs 111-116 as illustrated in FIG. 1 and BSs 101-103 as illustrated in FIG. 1). An embodiment of the method 1200 shown in FIG. 12 is for illustration only. One or more of the components illustrated in FIG. 12 can be implemented in specialized circuitry configured to perform the noted functions or one or more of the components can be implemented by one or more processors executing instructions to perform the noted functions.

As illustrated in FIG. 12, the method 1200 begins at step 1202. In step 1202, a first network entity identifies a plurality of carrier frequencies for measuring carrier phases from a set of predefined carrier frequencies.

In step 1204, the first network entity estimates, based on the measured carrier phases, a distance between the first network entity and a second network entity using a carrier ranging operation that is performed between the first network entity and the second network entity.

In step 1206, the first network entity selects, based on the estimated distance, historical information, a variation of measured distance, and channel status information, at least one carrier frequency from the plurality of carrier frequencies to refine distance measurement.

In step 1208, the first network entity transmits to and receive from, the second network entity, signals over the selected at least one carrier frequency.

In one embodiment, the first network entity determines the plurality of carrier frequencies for measuring carrier phases based on an availability of channels, interference of the channels, and existing channel selection results based on a channel selection algorithm.

In one embodiment, first network entity determines one or two carrier frequencies for measuring carrier phases from the plurality of carrier frequencies based on initial estimation of distance, a variance of distance, historic estimation results, and use cases.

In one embodiment, the first network entity selects one carrier frequency for measuring carrier phase when a carrier wavelength is more than a predefined threshold that multiplies a variance of distance error and selects two carrier frequencies for measuring carrier phases when the carrier wavelength of a beat frequency is more than a predefined threshold that multiplies the variance of distance error.

In one embodiment, the first network entity estimates, based on the measured carrier phase or carrier phases, a fractional number of cycles of a carrier wavelength or a beat carrier wavelength; estimates, based on a previously estimated distance, a carrier wavelength of the selected carrier phase or phases, and the estimated fractional number of cycles of the carrier wavelength or a beat carrier wavelength, an integer number of cycles of the carrier wavelength or beat carrier wavelength; and determines the updated distance measurement between the first network entity and the second network entity based on at least one of the estimated fractional number of cycles, an integer number of cycles, the carrier wavelength, or beat carrier wavelength.

In one embodiment, the first network entity determines a distance measurement variance based on at least one of a variance of system phase measurement, a carrier wavelength, or a beat carrier wavelength; selects, another carrier frequency from the plurality of carrier frequencies based on the determined distance measurement variance and previously used carrier frequencies; estimates, based on the measured carrier phase, a fractional number of cycles of the beat carrier wavelength; estimates, based on a previously estimated distance, the carrier wavelength of the selected carrier phase, and the estimated fractional number of cycles of the beat carrier wavelength, an integer number of cycles of the beat carrier wavelength; and determines, the updated distance measurement between the first network entity and the second network entity based on the estimated fractional number of cycles, the integer number of cycles, and the beat carrier wavelength.

In such embodiment, the variance of estimated distance is calculated by multiplying the variance of system carrier phase with the carrier wavelength or the beat carrier wavelength.

In one embodiment, the first network entity determines, based on estimated distance measurement variance, a distance estimation frequency, and a distance measurement accuracy requirement, a stop condition for a carrier frequency selection; and outputs the estimated distance measurement and the estimated measurement variance.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A first network entity for operating multiple carriers, the first network entity comprising:
a processor configured to:
identify a plurality of carrier frequencies for measuring carrier phases from a set of predefined carrier frequencies,
estimate, based on the measured carrier phases, a distance between the first network entity and a second network entity using a carrier ranging operation that is performed between the first network entity and the second network entity,
select, based on the estimated distance, historical information, a variation of measured distance, and channel status information, at least one carrier frequency from the plurality of carrier frequencies to refine distance measurement; and
a transceiver operably coupled to the processor, the transceiver configured to transmit to and receive from, the second network entity, signals over the selected at least one carrier frequency.

2. The first network entity of claim 1, wherein the processor is further configured to:
determine the plurality of carrier frequencies for measuring carrier phases based on an availability of channels, interference of the channels, and existing channel selection results based on a channel selection algorithm.

3. The first network entity of claim 1, wherein the processor is further configured to:
determine one or two carrier frequencies for measuring carrier phases from the plurality of carrier frequencies based on initial estimation of distance, a variance of distance, historic estimation results, and use cases;
select one carrier frequency for measuring carrier phase when a carrier wavelength is more than a predefined threshold that multiplies a variance of distance error; and
select two carrier frequencies for measuring carrier phases when the carrier wavelength of a beat frequency is more than a predefined threshold that multiplies the variance of distance error.

4. The first network entity of claim 1, wherein the processor is further configured to:
estimate, based on the measured carrier phase or carrier phases, a fractional number of cycles of a carrier wavelength or a beat carrier wavelength;
estimate, based on a previously estimated distance, a carrier wavelength of the selected carrier phase or phases, and the estimated fractional number of cycles of the carrier wavelength or a beat carrier wavelength, an integer number of cycles of the carrier wavelength or beat carrier wavelength; and
determine the updated distance measurement between the first network entity and the second network entity based on at least one of the estimated fractional number of cycles, an integer number of cycles, the carrier wavelength, or beat carrier wavelength.

5. The first network entity of claim 1, wherein the processor is further configured to:
determine a distance measurement variance based on at least one of a variance of system phase measurement, a carrier wavelength, or a beat carrier wavelength;
select, another carrier frequency from the plurality of carrier frequencies based on the determined distance measurement variance and previously used carrier frequencies;
estimate, based on the measured carrier phase, a fractional number of cycles of the beat carrier wavelength;
estimate, based on a previously estimated distance, the carrier wavelength of the selected carrier phase, and the estimated fractional number of cycles of the beat carrier wavelength, an integer number of cycles of the beat carrier wavelength; and
determine, the updated distance measurement between the first network entity and the second network entity based on the estimated fractional number of cycles, the integer number of cycles, and the beat carrier wavelength.

6. The first network entity of claim 5, wherein the variance of estimated distance is calculated by multiplying the variance of system carrier phase with the carrier wavelength or the beat carrier wavelength.

7. The first network entity of claim 1, wherein the processor is further configured to:
determine, based on estimated distance measurement variance, a distance estimation frequency, and a distance measurement accuracy requirement, a stop condition for a carrier frequency selection; and
output the estimated distance measurement and the estimated measurement variance.

8. A method of a first network entity for operating multiple carriers, the method comprising:
identifying a plurality of carrier frequencies for measuring carrier phases from a set of predefined carrier frequencies;
estimating, based on the measured carrier phase, a distance between the first network entity and a second network entity using a carrier ranging operation that is performed between the first network entity and the second network entity;
selecting, based on the estimated distance, historical information, a variation of measured distance, and channel status information, at least one carrier frequency from the plurality of carrier frequencies to refine distance measurement; and
transmitting, to and receive from the second network entity, signals over the selected at least one carrier frequency.

9. The method of claim 8, further comprising:
determining the plurality of carrier frequencies for measuring carrier phases based on an availability of channels, interference of the channels, and existing channel selection results based on a channel selection algorithm.

10. The method of claim 8, further comprising:
determining one or two carrier frequencies for measuring carrier phases from the plurality of carrier frequencies based on initial estimation of distance, a variance of distance, historic estimation results, and use cases;
selecting one carrier frequency for measuring carrier phase when a carrier wavelength is more than a predefined threshold that multiplies a variance of distance error; and
selecting two carrier frequencies for measuring carrier phases when the carrier wavelength of a beat frequency is more than a predefined threshold that multiplies the variance of distance error.

11. The method of claim 8, further comprising:
estimating, based on the measured carrier phase or carrier phases, a fractional number of cycles of a carrier wavelength or a beat carrier wavelength;
estimating, based on a previously estimated distance, a carrier wavelength of the selected carrier phase or phases, and the estimated fractional number of cycles of the carrier wavelength or a beat carrier wavelength, an integer number of cycles of the carrier wavelength or beat carrier wavelength; and
determining, the updated distance measurement between the first network entity and the second network entity, based on the estimated fractional number of cycles and integer number of cycles and the carrier wavelength or beat carrier wavelength.

12. The method of claim 8, further comprising:
determining a distance measurement variance based on at least one of a variance of system phase measurement, a carrier wavelength, or a beat carrier wavelength;
selecting, another carrier frequency from the plurality of carrier frequencies based on the determined distance measurement variance and previously used carrier frequencies;
estimating, based on the measured carrier phase, a fractional number of cycles of the beat carrier wavelength;
estimating, based on a previously estimated distance, the carrier wavelength of the selected carrier phase, and the estimated fractional number of cycles of the beat carrier wavelength, an integer number of cycles of the beat carrier wavelength; and
determining, the updated distance measurement between the first network entity and the second network entity based on the estimated fractional number of cycles, an integer number of cycles, and the beat carrier wavelength.

13. The method of claim 12, wherein the variance of estimated distance is calculated by multiplying the variance of system carrier phase with the carrier wavelength or the beat carrier wavelength.

14. The method of claim 8, further comprising:
determining, based on estimated a distance measurement variance distance, a distance estimation frequency, and a distance measurement accuracy requirement, a stop condition for carrier frequency selection; and
outputting the estimated distance measurement and the estimated measurement variance.

15. A non-transitory computer-readable medium comprising program code, that when executed by at least one processor, causes an electronic device to:
identify a plurality of carrier frequencies for measuring carrier phases from a set of predefined carrier frequencies;
estimate, based on the measured carrier phases, a distance between a first network entity and a second network entity using a carrier ranging operation that is performed between the first network entity and the second network entity;
select, based on the estimated distance, historical information, a variation of measured distance, and channel status information, at least one carrier frequency from the plurality of carrier frequencies to redefine distance measurement; and
transmit, to and receive from the second network entity, signals over the selected at least one carrier frequency.

16. The non-transitory computer-readable medium of claim 15, further comprising program code, that when executed by at least one processor, causes an electronic device to:
determine the plurality of carrier frequencies for measuring carrier phases based on an availability of channels, interference of the channels, and existing channel selection results based on a channel selection algorithm.

17. The non-transitory computer-readable medium of claim 15, further comprising program code, that when executed by at least one processor, causes an electronic device to:
determine one or two carrier frequencies for measuring carrier phases from the plurality of carrier frequencies based on initial estimation of distance, a variance of distance, historic estimation results, and use cases;
select one carrier frequency for measuring carrier phase when a carrier wavelength is more than a predefined threshold that multiplies a variance of distance error; and
select two carrier frequencies for measuring carrier phases when the carrier wavelength of a beat frequency is more than a predefined threshold that multiplies the variance of distance error.

18. The non-transitory computer-readable medium of claim 15, further comprising program code, that when executed by at least one processor, causes an electronic device to:
estimate, based on the measured carrier phase or carrier phases, a fractional number of cycles of a carrier wavelength or a beat carrier wavelength;
estimate, based on a previously estimated distance, a carrier wavelength of the selected carrier phase or phases, and the estimated fractional number of cycles of the carrier wavelength or beat carrier wavelength, an integer number of cycles of the carrier wavelength or a beat carrier wavelength; and
determine the updated distance measurement between the first network entity and the second network entity based on the estimated fractional number of cycles, an integer number of cycles, the carrier wavelength, or beat carrier wavelength.

19. The non-transitory computer-readable medium of claim 15, further comprising program code, that when executed by at least one processor, causes an electronic device to:
determine a distance measurement variance based on a variance of system phase measurement and carrier wavelength or a beat carrier wavelength;
select, another carrier frequency from the plurality of carrier frequencies based on the determined distance measurement variance and previously used carrier frequencies;
estimate, based on the measured carrier phase, a fractional number of cycles of the beat carrier wavelength;
estimate, based on a previously estimated distance, the carrier wavelength of the selected carrier phase, and the estimated fractional number of cycles of the beat carrier wavelength, an integer number of cycles of the beat carrier wavelength; and
determine, the updated distance measurement between the first network entity and the second network entity based on the estimated fractional number of cycles, the integer number of cycles, and the beat carrier wavelength.

20. The non-transitory computer-readable medium of claim 15, further comprising program code, that when executed by at least one processor, causes an electronic device to:
determine, based on estimated distance measurement variance, a distance estimation frequency, and a distance measurement accuracy requirement, a stop condition for a carrier frequency selection; and
output the estimated distance measurement and the estimated measurement variance.
